(19) United States
(12) Patent Application Publication
(10) Pub. No.: US 2017/0193635 A1
(43) Pub. Date: Jul. 6, 2017

(54) METHOD AND APPARATUS FOR RAPIDLY RECONSTRUCTING SUPER-RESOLUTION IMAGE

(71) Applicant: PEKING UNIVERSITY SHENZHEN GRADUATE SCHOOL, Shenzhen (CN)

(72) Inventors: Yang ZHAO, Shenzhen (CN); Ronggang WANG, Shenzhen (CN); Zhenyu WANG, Shenzhen (CN); Wen GAO, Shenzhen (CN); Wenmin WANG, Shenzhen (CN); Shengfu DONG, Shenzhen (CN); Tiejun HUANG, Shenzhen (CN); Siwei MA, Shenzhen (CN)

(73) Assignee: PEKING UNIVERSITY SHENZHEN GRADUATE SCHOOL, Shenzhen (CN)

(21) Appl. No.: 15/314,104

(22) PCT Filed: May 28, 2014
(86) PCT No.: PCT/CN2014/078612

§ 371 Date: Nov. 28, 2016

(51) Int. Cl. G06T 3/40; G06T 5/50

(52) U.S. Cl. CPC G06T 3/4053; G06T 5/50; G06T 2207/20221; G06T 2207/20028

(57) ABSTRACT

A method and apparatus for rapidly reconstructing a super-resolution image. In the method and apparatus for rapidly reconstructing a super-resolution image provided in the present application, an original image is processed at least by means of iterative backward mapping based on a texture structural constraint during reconstruction of a super-resolution image of the original image, so as to enhance texture details of the image, thereby improving the high-frequency detail quality of the super-resolution image.

### CROSS-REFERENCE TO RELATED APPLICATIONS

This application is a National Stage Appl. filed under 35 USC 371 of International Patent Application No. PCT/CN2014/078612 with an international filing date of May 28, 2014, designating the United States, now pending. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, Mass. 02142.

### FIELD OF THE INVENTION

The present application relates to the field of super resolution of video images, and more particularly to a method and an apparatus for reconstructing a super-resolution image.

### BACKGROUND OF THE INVENTION

Super-resolution reconstruction refers to the process of recovery of clear, high-resolution images from low-resolution images. Super resolution reconstruction is one of the fundamental technologies in the field of video image processing, and it has a very broad application prospect in such fields as medical image processing, image recognition, digital photo processing, and high-definition television.

One of the classical super-resolution image reconstruction methods is based on kernel-based interpolation algorithm, for example, bilinear interpolation, spline interpolation, and the like. Since such a method generates continuous data from discrete known data, it will result in fuzzy, jagged and other effects, also it cannot recover high-frequency details that are lost in low-resolution image. In recent years, many edge-based super-resolution image reconstruction methods have been proposed to ameliorate unnatural effects of conventional interpolation methods and improve visual quality of edges, by using prior knowledge about edges, such as gradient and geometric properties. However, this class of methods, which focus on improving visual quality of edges, still cannot recover high-frequency textural details. In order to recover high-frequency details, some sample-based methods also have been successively proposed to recover detailed information lost in a low-resolution image, by training low-resolution and their corresponding high-resolution dictionary libraries. However, in such methods, training of dictionaries and matching of dictionary elements block-by-block are extremely time-consuming.

### SUMMARY OF THE INVENTION

The present application provides a method and an apparatus for reconstructing a super-resolution image. When using the method, high-frequency details of an image are rapidly recovered. The method and apparatus solve the problem of poor quality of high-frequency details of a super-resolution image in the prior art.

In accordance with one embodiment of the invention, there is provided a method for reconstructing a super-resolution image. The method comprises processing an original image at least using iterative back-projection based on texture-structure constraints to enhance textural details of the original image during a procedure of reconstructing a super-resolution image from the original image.

In a class of this embodiment, the using the iterative back-projection based on the texture-structure constraints comprises:
inputting the original image;
performing the iterative back-projection based on the texture-structure constraints on the original image to obtain a first super-resolution image;
extracting edge regions from the original image to generate an edge image;
performing super-resolution image reconstruction on the edge image based on an edge region dictionary to obtain a second super-resolution image; wherein the edge region dictionary comprises low-resolution samples and high-resolution samples corresponding to the low-resolution samples; and
synthesizing the first super-resolution image with the second super-resolution image to obtain a super-resolution image of the original image.

In a class of this embodiment, when extracting the edge image comprising information of the edge regions from the original image, sharp-edge portions of the original image and transition-region portions within a pre-set area range of the sharp-edge portions are all extracted as the edge regions.

In a class of this embodiment, after determination of the edge regions, the edge regions are performed with morphological processing.

In a class of this embodiment, the texture-structure constraints comprise: in the original image, for the texture regions with large grayscale changes, increasing a coefficient for iteration-increment of high-frequency information; and for the texture regions with small grayscale changes, decreasing the coefficient for iteration-increment of high-frequency information.

In a class of this embodiment, the performing the iterative back-projection based on the texture-structure constraints on the original image to obtain the first super-resolution image, comprises:
pre-processing the original image to obtain a preprocessed image; and
performing iterative back-projection based on the texture-structure constraints to the preprocessed image to obtain the first super-resolution image.

In a class of this embodiment, the preprocessing comprises bilateral filtering.

In a class of this embodiment, the synthesizing the first super-resolution image with the second super-resolution image to obtain the super-resolution image of the original image comprises: performing mean-value calculation on the transition-region portions in the first super-resolution image and the second super-resolution image, and allowing mean values at centers of the grayscale distributions to overlap by mean-value correction to obtain the super-resolution image of the original image.

In a class of this embodiment, the method further comprises: after the mean-value correction, adjusting grayscale values of the transition-region portions by performing a preset number of iterative back-projection on the transition-region portions to obtain the super-resolution image of the original image.

In accordance with another embodiment of the invention, there is provided an apparatus for reconstructing a super-resolution image. The apparatus comprises:
A) an original image acquisition unit, which is configured to acquire an original image; and
B) a super-resolution image reconstruction module, which is configured to perform iterative back-projection based on texture-structure constraints on the original image during a procedure of reconstructing a super-resolution image from the original image to enhance textural details of the original image.

In a class of this embodiment, the super-resolution image reconstruction module comprises:
a first super-resolution image reconstruction unit, which is configured to perform the iterative back-projection based on the texture-structure constraints on the original image to obtain a first super-resolution image;
an edge-image extraction unit, which is configured to extract edge regions from the original image to generate an edge image;
a second super-resolution image reconstruction unit, which is configured to perform super-resolution image reconstruction on the edge image based on an edge region dictionary to obtain a second super-resolution image;
wherein the edge region dictionary comprises low-resolution samples and high-resolution samples corresponding to the low-resolution samples; and
a synthesis unit, which is configured to synthesize the first super-resolution image with the second super-resolution image to obtain the super-resolution image of the original image.

In a class of this embodiment, when the edge regions are extracted from the original image by the edge-image extraction unit to generate the edge image, sharp-edge portions of the original image and transition-region portions within a pre-set area range of the sharp-edge portions are extracted by the edge-image extraction unit as the edge regions.

In a class of this embodiment, the edge-image extraction unit is further configured to perform morphological processing on the edge regions after extraction of the edge regions from the original image.

In a class of this embodiment, the texture-structure-based constraints comprises: in the original image, for the texture regions with large grayscale changes, increasing the coefficient for iteration-increment of high-frequency information; and for the texture regions with small grayscale changes, decreasing the coefficient for iteration-increment of high-frequency information.

In a class of this embodiment, when the iterative back-projection based on the texture-structure constraints is performed on the original image by first super-resolution image reconstruction unit to obtain the first super-resolution image, the original image is pre-processed by the first super-resolution image reconstruction unit to obtain the preprocessed image, and the iterative back-projection based on the texture-structure constraints is then performed on the preprocessed image to obtain the first super-resolution image.

In a class of this embodiment, when pre-processing the original image by the first super-resolution image reconstruction unit, bilateral filtering is adopted by the first super-resolution image reconstruction unit to preprocess the original image.

In a class of this embodiment, when the first super-resolution image is synthesized with the second super-resolution image by the synthesis unit to obtain the super-resolution image of the original image, mean-value calculation is performed on the transition-region portions in the first super-resolution image and the second super-resolution image, and mean values at centers of the grayscale distributions are overlapped by mean-value correction to obtain the super-resolution image of the original image.

In a class of this embodiment, the synthesis unit is also configured for mean-value correction; after the mean values at centers of the grayscale distributions are overlapped by the mean-value correction, grayscale values of the transition-region portions are adjusted by performing a preset number of iterative back-projection on the transition-region portions to obtain the super-resolution image of the original image.

The present invention provides a method and an apparatus for fast super-resolution image reconstruction, which, during the procedure of reconstructing a super-resolution image from an original image, employs at least an iterative back-projection based on the texture-structure constraints to process the original image, to enhance the textural details of the image, thereby improving the quality of the high-frequency details of the super-resolution image.

### BRIEF DESCRIPTION OF THE DRAWINGS

FIG. 1 is a flowchart of a method for reconstructing a super-resolution image in accordance with one embodiment of the invention;

FIG. 2 is a schematic diagram of a procedure from an original image to an output image (a super-resolution image of the original image) in a method for reconstructing a super-resolution image in accordance with one embodiment of the invention;

FIG. 3 is a comparison diagram illustrating PSNRs (peak signal-to-noise ratio) on a texture image, resulted from implementation of super-resolution image reconstruction on four different images by using Bicubic interpolation, ICBI method, ScSR method, and a method for reconstructing a super-resolution image in accordance with one embodiment of the invention, respectively;

FIG. 4 is a comparison diagram illustrating the processing time for implementation of super-resolution image reconstruction on five different images by using Bicubic interpolation, ICBI method, ScSR method, and a method for reconstructing a super-resolution image in accordance with one embodiment of the invention, respectively; and

FIG. 5 is a schematic block diagram of an apparatus for reconstructing a super-resolution image in accordance with one embodiment of the invention.

### DETAILED DESCRIPTION OF THE PREFERRED EMBODIMENTS

Hereinafter, the present application will be described in further detail by way of specific embodiments in conjunction with the accompanying drawings.

### Example 1

A method for reconstructing a super-resolution image is provided, which, during the procedure of reconstructing a super-resolution image from an original image, employs at least an iterative back-projection based on the texture-structure constraints to process the original image, to enhance the textural details of the image.

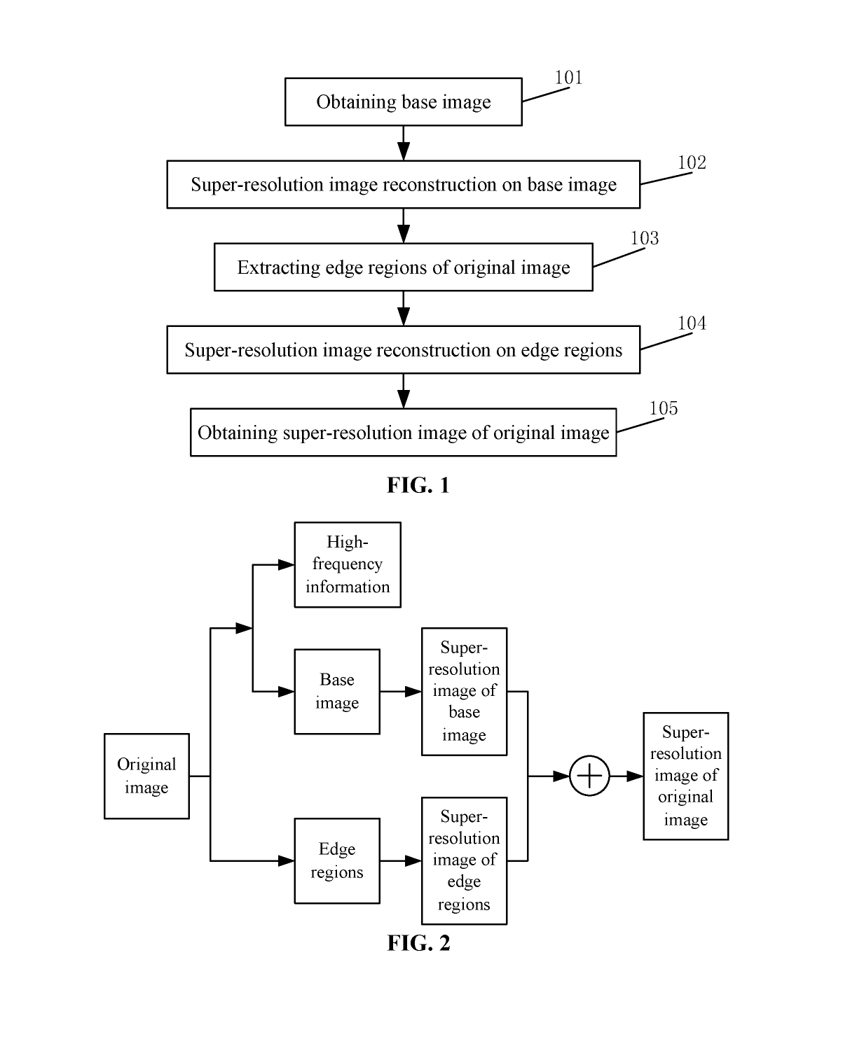

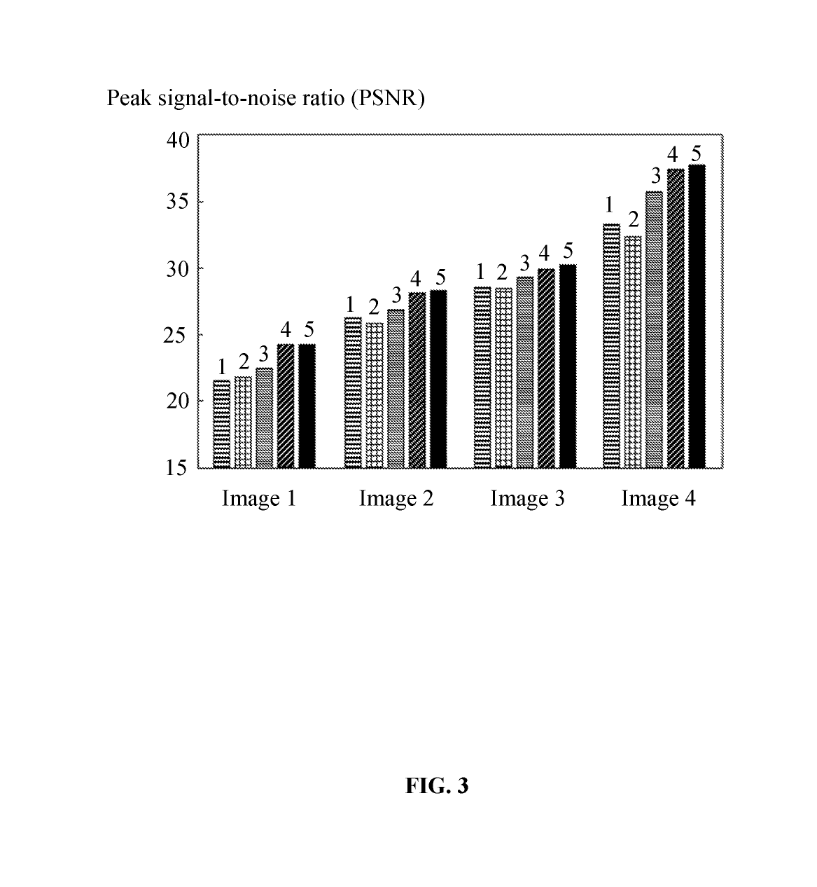

In a particular embodiment, references are made to FIG. 1 and FIG. 2, FIG. 1 is a flowchart of the method for reconstructing the super-resolution image according to this embodiment, and FIG. 2 is a schematic diagram of a procedure from an original image to an output image (a super-resolution image of the original image) with the use of the method for reconstructing the super-resolution image according to this embodiment.

The method for reconstructing the super-resolution image comprises:

Step 101: pre-processing the original image to obtain a preprocessed image. In this embodiment, specifically, the high-frequency information of the original image is removed to obtain a base image, which is a preprocessed image. In other embodiments, the original image may not be preprocessed, or other preprocessing ways may be employed.

In a particular embodiment, in step 101, bilateral filtering may be employed to remove high-frequency information of the original image to obtain a base image, and the bilateral filtering applies the following filtering formula:

$$\begin{matrix}g ( x ) = \frac{{\sum }_{y ∈ Ω} I ( y ) ω ( x , y )}{{\sum }_{y ∈ Ω} ω ( x , y )} & ( 1 ) \\ ω ( x , y ) = exp ( - \frac{{‖ x - y ‖}_{2}^{2}}{2 {σ}_{c}^{2}} - \frac{{‖ I ( x ) - I ( y ) ‖}_{2}^{2}}{2 {σ}_{s}^{2}} ) & ( 2 )\end{matrix}$$

where, x, y represent coordinates of a center pixel and a neighbor pixel, respectively, I(x), I(y) are the grayscale values corresponding to the center pixel and the neighbor pixel, Ω is a preset pixel region centered at x, and σ is an empirical parameter value.

Compared with single-kernel Gaussian filtering, bilateral filtering takes the grayscale relation and the positional relationship between pixels into accounts, therefore it achieves better separation of the high-frequency information of the image.

Step 102: employing a texture-structure-based IBP for super-resolution image reconstruction on the base image, to obtain a first super-resolution image.

First, in the following, the steps of super-resolution image reconstruction with an IBP will be described:

For example: X represents a high-resolution image, Y represents a low-resolution image, X* is defined as a super-resolution image reconstructed from X. Super resolution refers to obtain X* for a given low-resolution image Y. It should be noted that a high-resolution image is defined as an image obtained from enlargement of a low-resolution image in an iterative process. A super-resolution image (super-resolution reconstruction image) is a final result obtained after super-resolution image reconstruction of a low-resolution image.

The constraints for BP are as follows: the final result X is a high-resolution image obtained from enlargement of Y, so DHX*(which is obtained by reduction of X) and Y should be as similar as possible.

Specifically, the iterative process is as follows:

(1) with an interpolation approach, upsampling on Y, to obtain a first enlarged high-resolution image X₁.

(2) downsampling on X₁, to obtained a down-sampled low-resolution image Y₁=DHX₁.

(3) comparing Y₁ and Y, to obtain a high-frequency residual: R₁=Y−Y₁.

(4) enlarging the residual by multiplication with a predetermined factor, then adding to X₁, to obtain X₂:

X₂=X₁H^{T}UR₁ (equivalent to adding high-frequency detail information to X₁).

(5) downsampling on X₂, to obtain Y₂.

(6) calculating the residual R₂=Y−Y₂, then enlarging the residual R₂ and adding to X₂, to obtain X₃:

X₃=X₂±H^{T}UR₂

(7) Repeating the above steps, to finally obtain X*. The resulting X* satisfies the following condition: DHX*(which is obtained by downsampling) and the given Y are as similar as possible, that is, it meets ∥DHX*−Y∥2<ε, where ε is a minimum value.

Keeping the super-resolution image consistent with the given low-resolution image is one of the basic constraints for super-resolution images, although an iterative back-projection may be employed to recover high-frequency details, direct BP however will lead to many problems such as fuzzy edges, besides, high-frequency noise will be raised in the iterative process, which is particularly evident in a flat-texture region. In tradition constraints, texture-structure is often ignored. Therefore, preferably, in this embodiment, with a base image as an initial value, an iterative back-projection based on texture-structure constraints is employed for super-resolution image reconstruction on the base image, to recovery high-frequency information of the base image, namely:

$${X}^{⋆} = arg {min}_{X} E ( X \vert Y , T ) \qquad ( 3 )$$

where, X is a high-resolution image, Y is a low-resolution image, X* is a super-resolution reconstruction image, T is a texture-structure matrix. The role of T is: for the texture regions with acute grayscale changes, to increase the coefficient for iteration-increment of high-frequency information, and for the flat-texture regions, to decrease increment of high-frequency information so as to suppress the noise that may arise. In the matrix T, each element t represents the local grayscale variance of a respective pixel on an image, and t is calculated as follows:

$$t = {\sum }_{i = 1}^{p} \vert {g}_{i} - {g}_{c} \vert \qquad ( 4 )$$

where, g_{c} is the grayscale value of the center pixel for a local image block, gᵢ is the grayscale value of the ith neighboring pixel of the center pixel, and p is the number of the neighboring pixels of the center pixel.

After introduction of texture-structure constraints, the texture-structure-constraints-based BP iteration formula is as follows:

Xₜ₊₁=vT_{c}TH^{T}U(DHXₜ−Y)+Xₜ (5)

where, Xₜ and Xₜ₊₁ are the high-resolution images obtained at the tth and the t+1th iterations respectively, D and U are downsampling and upsampling operations respectively, H is the blurring operation, T is the texture-structure matrix, T_{c} is the coefficient matrix of the texture-structure matrix T, and in a particular embodiment, a larger value in the matrix T is imparted with a relatively large coefficient, while a smaller value in the matrix T is imparted with a relatively small coefficient, v is a preset parameter.

Hereinafter, an example of super-resolution image reconstruction on a base image by using iterative back-projection based on texture-structure constraints according to this embodiment will be described.

For example, for a given low-resolution image with its background being flat sky and its foreground being a portrait, after enlargement, the textures that need to be principally recovered are usually human hair, skin details, etc., whereas the sky's texture changes are mild. With a traditional BP approach, after several iterative processes, high-frequency information of the image will be gradually increased, however, because the enlarging operation in such an approach does not have constraints on textures, for example, if high-frequency noise is present in the flat-sky background portion, then the noise will be continually amplified and intensified in the iterative processes.

In this embodiment, because of introduction of texture constraints, by extracting texture features, a texture template (a local-grayscale-variance template) can be created for an image. With this approach, the iteration result is as follow: high-frequency details for the regions with acute texture changes, such as human hair, will be further intensified, whereas recovering of high-frequency information for the mild-changing sky background is suppressed to avoid the noise information that may arise.

Step 103: extracting edge regions of the original image.

In a particular embodiment, when extracting edge regions of the original image, sharp-edge portions of the original image and transition-region portions within a pre-set area range of the sharp-edge portions are all chosen as the edge regions. Specifically, the following formula is employed to extract the edge regions of the original image:

$$G = s ( t - c ) = s ( {\sum }_{i = 1}^{P} \vert {g}_{i} - {g}_{c} \vert - c ) , S ( x ) = \{ \begin{matrix}1 , & x > 0 \\ 0 , & x < 0\end{matrix} \qquad ( 6 )$$

where, c is the threshold value for detection of the edge regions. In this embodiment, with such an edge-region extraction method, not only the sharp edges but also the pixel points near the edges (i.e., the transition-region portions) can be extracted, in order to achieve better transition from the edge regions to adjacent texture regions after super-resolution reconstruction.

Further, after extraction of the edge regions of the original image, the extracted edge regions also undergo morphological processing (expansion and corrosion treatment). Since the edge-region extraction is a binary operation, thus, in order to ensure the continuity of the edges, morphological processing is performed, which can eliminate the tiny gaps (broken points) in a continuous edge.

Step 104: performing dictionary-based super-resolution image reconstruction on the edge regions, to obtain a super-resolution image of the edge regions. The dictionary includes low-resolution samples and high-resolution samples corresponding to the low-resolution samples.

In a particular embodiment, the acquisition of the dictionary comprises steps as follows: extracting high-resolution local-block features of a training image; extracting low-resolution local-block features corresponding to the high-resolution local-block features; using sparse coding to train samples, to obtain a dictionary.

When using sparse coding to train samples, the following optimization formula is applied:

$$D = arg {min}_{D , Z} {‖ X - DZ ‖}_{2}^{2} + λ {‖ Z ‖}_{1} \qquad ( 7 )$$

where, D is the dictionary obtained from the training process, X is a high-resolution training image, λ is a preset coefficient, specifically, λ may be an empirical value, norm term L₁ is a sparseness constraint, norm term L₂ is a constraint of the similarity between a dictionary-reconstructed local block and a local block of training samples. When training samples, firstly, D is fixed and linear programming is used to solve Z, then Z is fixed and quadratic programming is used to solve an optimal D and update D; the above process is repeated in iteration until the dictionary D training is completed, where the dictionary D meets a termination condition which is stated as follows: errors of the dictionary D obtained from the training process are within a permitted range.

The dictionary D includes low-resolution samples D₁ and their corresponding high-resolution samples Dₕ, so, in dictionary-matching process, for an input low-resolution local block y, its high-resolution reconstruction block x may be expressed as follows by using a high-resolution dictionary element:

x≈Dₕα (8)

where α is a coefficient, for example, in this embodiment, low-resolution reconstruction is employed to solve the coefficient, and the low-resolution reconstructed coefficient α satisfies the following constraint:

min∥α∥₀s.t.∥FD₁αF_{y}∥₂²≦ε (9)

where ε is a minimum value tending to 0, F is a local-feature extraction operation, and in the dictionary D according to this embodiment, the extracted feature is local grayscale variance in combination with gradient magnitude. Since a is sparse enough, norm L1 is used to substitute norm L0 of formula (9), and the optimization problem turns as below:

$${min}_{α} {‖ {FD}_{1} α - Fy ‖}_{2}^{2} + λ {‖ α ‖}_{1} \qquad ( 10 )$$

where, λ is a coefficient for adjustment of sparseness and similarity, and by solving the above Lasso problem, the optimal sparseness expression a can be obtained and then substituted into the formula (8), so that the super-resolution result x corresponding to y can be calculated.

Step 105: synthesizing the super-resolution image of the base image with the super-resolution image of the edge regions, to obtain a super-resolution image of the original image.

Since the texture regions and the edge regions of the image are separately processed in this embodiment, there exists difference in the grayscale values of the super-resolution images of the texture regions and of the edge regions, thus, direct synthesizing will result in an uncoordinated visual effect in the transition-region portions. In order to eliminate this uncoordinated visual effect, in this embodiment, when synthesizing the super-resolution image of the base image with the super-resolution image of the edge regions, mean values of the transition-region portions in the super-resolution images of the base image and of the edge regions is calculated, so that through correction of the mean values, the mean values at the center of the grayscale distributions overlap.

After correction of the mean values, by performing a preset number of IBP to the transition-region portions, the grayscale values of the transition-region portions are adjusted, so that the transition-region portions are not only ensured smooth transition but also consistent with the given low-resolution image. In order to maintain the sharpness of the edges, the back-projection adjustment is performed only for a preset number of iterations on the portions where the sharp edge lines are removed (i.e., the transition-region portions), and a relatively small value is selected for the preset number.

It should be noted that, in the embodiments of the present application, the edge regions refer to sharp edges like obvious lines, curves, borders, etc. and their adjacent image block regions (the transition-region portions), while the other regions with mild-changing local grayscale variance with respect to the sharp-edge regions are collectively referred to as texture regions. It should be noted that, in traditional texture analysis, texture can be divided into two types, namely, structural texture and random texture. Structural texture has relatively strong edges, such as obvious lines, spots, lines, etc., which can be well handled in super-resolution process. In the embodiments of the present application, the texture regions mainly refer to random texture, such as detail portions of textures of skin, fur, feather, cloth, leaf, or the like.

With reference to FIG. 3, FIG. 3 shows the resulting PSNRs (peak signal-to-noise ratio) on four different texture images, with the use of Bicubic interpolation, ICBI method proposed by Giachett et al. in 2011 (A. Giachett and N. Asuni, “Real-time artifact-free image upscaling,” IEEE Transactions on Image Processing, vol. 20, no. 10, pp. 2760-2768, 2011), ScSR method proposed by Yang et al. in 2010 (J. Yang, J. Wright, T. S. Huang, et al, “Image super-resolution via sparse representation,” IEEE Transactions on Image Processing, vol. 19, no. 11, pp. 2861-2873, 2010), and the method for reconstructing the super-resolution image according to this embodiment, respectively where,
\textcircled{1} is the resulting PSNR of using Bicubic interpolation method for super-resolution image reconstruction;
\textcircled{2} is the resulting PSNR of using ICBI method for super-resolution image reconstruction;
\textcircled{3} is the resulting PSNR of using ScSR method for super-resolution image reconstruction;
\textcircled{4} is the resulting PSNR after super-resolution image reconstruction on the base image in this embodiment; and
\textcircled{5} is the resulting PSNR after synthesizing the super-resolution image of the base image with the super-resolution image of the edge regions in this embodiment.
   As can be seen from FIG. 3, the method for reconstructing the super-resolution image according to this embodiment results higher PSNR. Comparing \textcircled{4} and \textcircled{5} in FIG. 3, because the edge regions occupy a relatively small portion of the original image, so, after synthesizing the super-resolution image of the base image with the super-resolution image of the edge regions, although the PSNR value is enhanced a little, the textural details, sharp edges and edge detail information are very well recovered, which improves the visual quality of the output image.

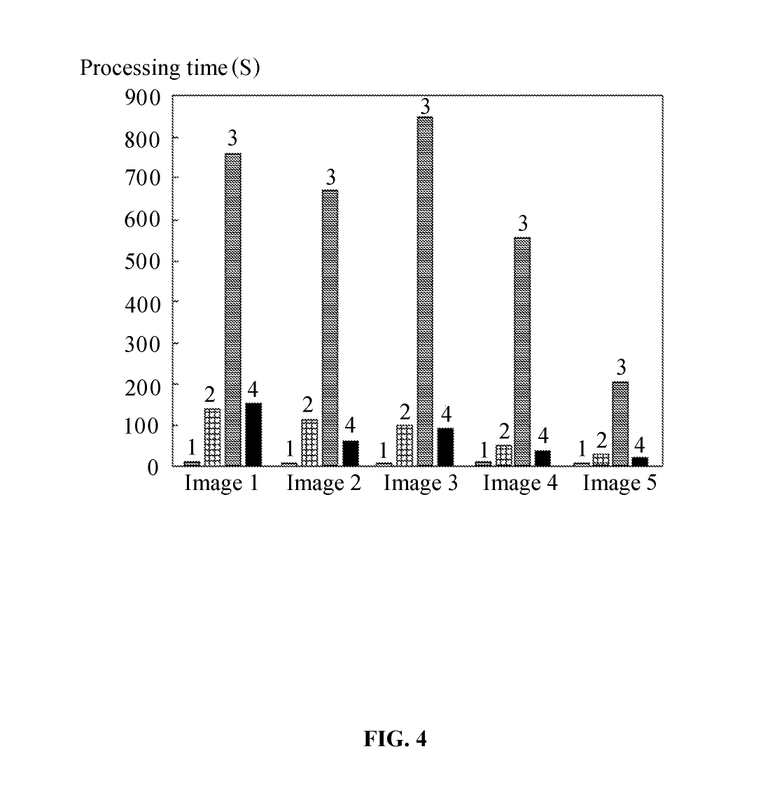

With reference to FIG. 4, FIG. 4 shows the results of processing time for implementation of super-resolution image reconstruction on five different images, with the use of Bicubic interpolation, ICBI method, ScSR method, and the method for reconstructing the super-resolution image according to this embodiment, respectively. where,
\textcircled{1} is the result of the processing time for implementation of super-resolution image reconstruction with Bicubic interpolation method;
\textcircled{2} is the result of the processing time for implementation of super-resolution image reconstruction with ICBI method;
\textcircled{3} is the result of the processing time for implementation of super-resolution image reconstruction with ScSR method; and
\textcircled{4} is the result of the processing time for implementation of super-resolution image reconstruction with the method according to this embodiment. As can be seen from FIG. 4, the method for reconstructing the super-resolution image according to this embodiment has great improvement in processing speed, compared with the method which simply uses a dictionary, and its time consumption is comparable to the ICBI method (which is a real-time algorithm) while achieving recovery of image details.

In the method for reconstructing the super-resolution image according to this embodiment, super-resolution image reconstruction is performed only on the edge regions of the original image with the use of a dictionary-based method, then this super-resolution image of the edge regions is synthesized with the super-resolution image (which is obtained by the iteration method) of the base image, so as to obtain the super-resolution image of the original image, thus, it can not only improve the quality of the high-frequency details of the super-resolution images, but also ensure relatively fast image-processing speed.

### Example 2

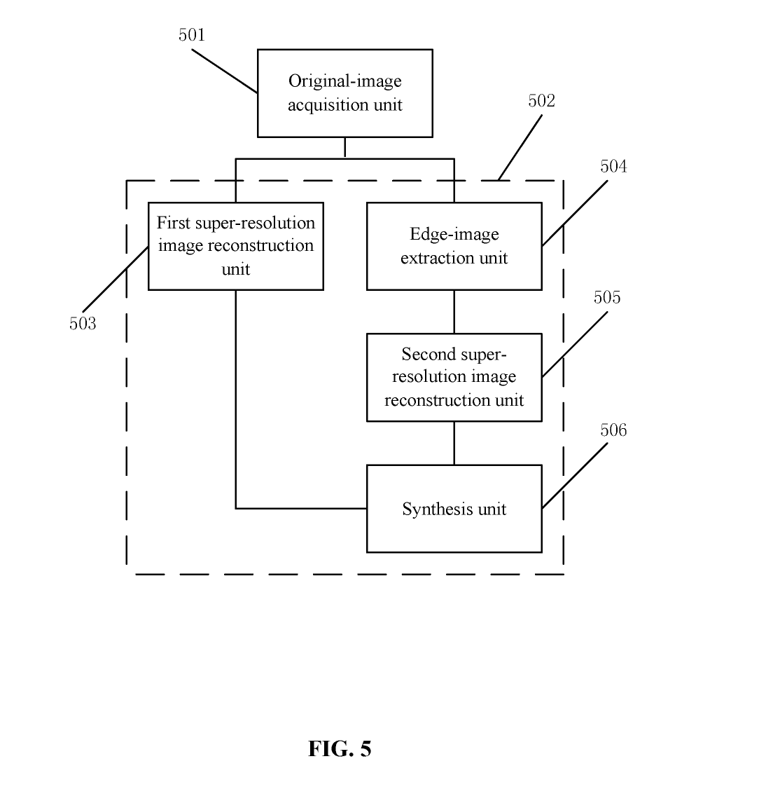

With reference to FIG. 5, based on the method for reconstructing the super-resolution image according to the first embodiment, this embodiment correspondingly provides an apparatus for reconstructing a super-resolution image, comprising an original image acquisition unit 501 and a super-resolution image reconstruction module 502.

The original-image acquisition unit 501 is configured for acquiring an original image.

The super-resolution image reconstruction module 502 is configured for, during the procedure of reconstructing a super-resolution image from the original image, employing at least an iterative back-projection based on the texture-structure constraints approach to process the original image, to enhance the textural details of the image.

In a particular embodiment, the super-resolution image reconstruction module 502 comprises a first super-resolution image reconstruction unit 503, an edge-image extraction unit 504, a second super-resolution image reconstruction unit 505 and a synthesis unit 506.

The first super-resolution image reconstruction unit 503 is configured to perform texture-structure-constraints-based IBP to the original image, to obtain a first super-resolution image.

The edge-image extraction unit 504 is configured to extract edge regions from the original image to generate an edge image.

The second super-resolution image reconstruction unit 505 is configured to perform super-resolution image reconstruction on the edge image based on an edge region dictionary to obtain a second super-resolution image. The dictionary includes low-resolution samples and high-resolution samples corresponding to the low-resolution samples.

The synthesis unit 506 is configured to synthesize the first super-resolution image with the second super-resolution image to obtain a super-resolution image of the original image.

When the edge-image extraction unit 504 extracts edge regions from the original image to generate an edge image: the edge-image extraction unit 504 extracts sharp-edge portions of the original image and transition-region portions within a pre-set area range of the sharp-edge portions as the edge regions.

The edge-image extraction unit 504 is also configured to perform morphological processing to the edge regions, after extraction of the edge regions from the original image.

In a particular embodiment, the texture-structure-based constraints comprise: in the original image, for the texture regions with large grayscale changes, increasing the coefficient for iteration-increment of high-frequency information; and for the texture regions with small grayscale changes, decreasing the coefficient for iteration-increment of high-frequency information.

when the first super-resolution image reconstruction unit 503 performs texture-structure-constraints-based IBP to the original image to obtain a first super-resolution image: the first super-resolution image reconstruction unit 503 performs pre-processing to the original image, to obtain a preprocessed image; then it performs texture-structure-constraints-based IBP to the preprocessed image, to obtain a first super-resolution image.

when the first super-resolution image reconstruction unit 503 performs pre-processing to the original image, the first super-resolution image reconstruction unit 503 employs bilateral filtering to preprocess the original image.

In a particular embodiment, the bilateral filtering applies a filtering formula as below:

$$g ( x ) = \frac{{\sum }_{y ∈ Ω} I ( y ) ω ( x , y )}{{\sum }_{y ∈ Ω} ω ( x , y )} \\ ω ( x , y ) = exp ( - \frac{{‖ x - y ‖}_{2}^{2}}{2 {σ}_{c}^{2}} - \frac{{‖ I ( x ) - I ( y ) ‖}_{2}^{2}}{2 {σ}_{s}^{2}} )$$

where, x, y represent coordinates of a center pixel and a neighbor pixel, respectively, I(x), I(y) are the grayscale values corresponding to the center pixel and the neighbor pixel, Ω is a preset pixel region centered at x, and σ is an empirical parameter value.

With the pre-processed image as an initial value, based on texture-structure constraints, when the first super-resolution image reconstruction unit employs an IBP approach for super-resolution image reconstruction on the pre-processed image, the IBP formula is as below:

Xₜ₊₁=vT_{c}TH^{T}U(DHXₜ−Y)+X₁

wherein, Xₜ and Xₜ₊₁ are the high-resolution images obtained at the tth and the t+1th iterations respectively, D and U are downsampling and upsampling operations respectively, H is the blurring operation, T is the texture-structure matrix, T_{c} is the coefficient matrix of the texture-structure matrix T.

Specifically, in the texture-structure matrix T, each element is calculated by the following formula:

$$t = {\sum }_{i = 1}^{P} \vert {g}_{i} - {g}_{c} \vert$$

where, g_{c} is the grayscale value of the center pixel for a local image block, gᵢ is the grayscale value of the ith neighboring pixel of the center pixel, and p is the number of the neighboring pixels of the center pixel.

It will be appreciated by those skilled in the art that, in the above-described embodiments, the preprocessing of the original image may also be other preprocessing, and in some embodiments, the original image may not be pre-processed.

In the apparatus for reconstructing the super-resolution image according to this embodiment, super-resolution image reconstruction is performed only on the edge regions of the original image with the use of a dictionary-based method, then this super-resolution image of the edge regions is synthesized with the super-resolution image (which is obtained by the iteration method) of the preprocessed image, so as to obtain the super-resolution image of the original image, thus, it can not only improve the quality of the high-frequency details of the super-resolution image, but also ensure relatively fast image-processing speed.

It will be appreciated by those skilled in the art that, all or a portion of the steps of the various methods in the above-described embodiments may be accomplished by a program which instructs associated hardware, and the program may be stored in a computer readable storage medium which may include: a read-only memory, a random access memory, a hard disk, or a CD.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A method for reconstructing a super-resolution image, the method comprising: processing an original image at least using iterative back-projection based on texture-structure constraints to enhance textural details of the original image during a procedure of reconstructing a super-resolution image from the original image.

2. The method of claim 1, wherein the using the iterative back-projection based on the texture-structure constraints, comprises:
inputting the original image;
performing the iterative back-projection based on the texture-structure constraints on the original image to obtain a first super-resolution image;
extracting edge regions from the original image to generate an edge image;
performing super-resolution image reconstruction on the edge image based on an edge region dictionary to obtain a second super-resolution image; wherein the edge region dictionary comprises low-resolution samples and high-resolution samples corresponding to the low-resolution samples; and
synthesizing the first super-resolution image with the second super-resolution image to obtain a super-resolution image of the original image.

3. The method of claim 2, wherein when extracting the edge image comprising information of the edge regions from the original image, sharp-edge portions of the original image and transition-region portions within a pre-set area range of the sharp-edge portions are all extracted as the edge regions.

4. The method of claim 3, wherein after determination of the edge regions, the edge regions are performed with morphological processing.

5. The method of any of claims 1-4, wherein the texture-structure constraints comprise: in the original image, for the texture regions with large grayscale changes, increasing a coefficient for iteration-increment of high-frequency information; and for the texture regions with small grayscale changes, decreasing the coefficient for iteration-increment of high-frequency information.

6. The method of claim 2, wherein the performing the iterative back-projection based on the texture-structure constraints on the original image to obtain the first super-resolution image, comprises:
pre-processing the original image to obtain a preprocessed image; and
performing iterative back-projection based on the texture-structure constraints to the preprocessed image to obtain the first super-resolution image.

7. The method of claim 6, wherein the preprocessing comprises bilateral filtering.

8. The method of any of claims 2-4, wherein the synthesizing the first super-resolution image with the second super-resolution image to obtain the super-resolution image of the original image comprises: performing mean-value calculation on the transition-region portions in the first super-resolution image and the second super-resolution image, and allowing mean values at centers of the grayscale distributions to overlap by mean-value correction to obtain the super-resolution image of the original image.

9. The method of claim 8, further comprising: after the mean-value correction, adjusting grayscale values of the transition-region portions by performing a preset number of iterative back-projection on the transition-region portions to obtain the super-resolution image of the original image.

10. An apparatus for reconstructing a super-resolution image, the apparatus comprising:
A) an original image acquisition unit, which is configured to acquire an original image; and
B) a super-resolution image reconstruction module, which is configured to perform iterative back-projection based on texture-structure constraints on the original image during a procedure of reconstructing a super-resolution image from the original image to enhance textural details of the original image.

11. The apparatus of claim 10, wherein the super-resolution image reconstruction module comprises:
a first super-resolution image reconstruction unit, which is configured to perform the iterative back-projection based on the texture-structure constraints on the original image to obtain a first super-resolution image;
an edge-image extraction unit, which is configured to extract edge regions from the original image to generate an edge image;
a second super-resolution image reconstruction unit, which is configured to perform super-resolution image reconstruction on the edge image based on an edge region dictionary to obtain a second super-resolution image; wherein the edge region dictionary comprises low-resolution samples and high-resolution samples corresponding to the low-resolution samples; and
a synthesis unit, which is configured to synthesize the first super-resolution image with the second super-resolution image to obtain the super-resolution image of the original image.

12. The apparatus of claim 11, wherein when the edge regions are extracted from the original image by the edge-image extraction unit to generate the edge image, sharp-edge portions of the original image and transition-region portions within a pre-set area range of the sharp-edge portions are extracted by the edge-image extraction unit as the edge regions.

13. The apparatus of claim 12, wherein the edge-image extraction unit is further configured to perform morphological processing on the edge regions after extraction of the edge regions from the original image.

14. The apparatus of any of claims 10-13, wherein the texture-structure-based constraints comprises: in the original image, for the texture regions with large grayscale changes, increasing the coefficient for iteration-increment of high-frequency information; and for the texture regions with small grayscale changes, decreasing the coefficient for iteration-increment of high-frequency information.

15. The apparatus of claim 11, wherein when the iterative back-projection based on the texture-structure constraints is performed on the original image by first super-resolution image reconstruction unit to obtain the first super-resolution image, the original image is pre-processed by the first super-resolution image reconstruction unit to obtain the preprocessed image, and the iterative back-projection based on the texture-structure constraints is then performed on the preprocessed image to obtain the first super-resolution image.

16. The apparatus of claim 15, wherein when pre-processing the original image by the first super-resolution image reconstruction unit, bilateral filtering is adopted by the first super-resolution image reconstruction unit to preprocess the original image.

17. The apparatus of any of claims 11-13, wherein when the first super-resolution image is synthesized with the second super-resolution image by the synthesis unit to obtain the super-resolution image of the original image, mean-value calculation is performed on the transition-region portions in the first super-resolution image and the second super-resolution image, and mean values at centers of the grayscale distributions are overlapped by mean-value correction to obtain the super-resolution image of the original image.

18. The apparatus of claim 17, wherein the synthesis unit is also configured for mean-value correction; after the mean values at centers of the grayscale distributions are overlapped by the mean-value correction, grayscale values of the transition-region portions are adjusted by performing a preset number of iterative back-projection on the transition-region portions to obtain the super-resolution image of the original image.
